(19) United States
(12) Patent Application Publication
(10) Pub. No.: US 2025/0162037 A1
(43) Pub. Date: May 22, 2025

(54) WASTE METAL POWDER PASSIVATION

(71) Applicant: Divergent Technologies, Inc., Los Angeles, CA (US)

(72) Inventors: Bahram ISSARI, Los Angeles, CA (US); Michael Thomas Kenworthy, Rancho Paloes Verdes, CA (US); Chan Cheong Pun, Costa Mesa, CA (US); Gordon Tajiri, Los Angeles, CA (US)

(21) Appl. No.: 18/957,226

(22) Filed: Nov. 22, 2024

Related U.S. Application Data
(60) Provisional application No. 63/601,992, filed on Nov. 22, 2023.

(51) Int. Cl. B22F 10/73; B22F 12/53; B22F 12/55; B23K 26/14; B23K 26/144; B33Y 10/00; B33Y 40/00; B33Y 80/00

(52) U.S. Cl. CPC B22F 10/73; B22F 12/53; B22F 12/55; B23K 26/144; B23K 26/1476; B33Y 10/00; B33Y 40/00; B33Y 80/00

(57) ABSTRACT

Aspects are provided for passivation of waste metal streams. An apparatus may include a three-dimensional (3-D) printer that produces a waste powder during 3-D printing of a printed part, a passivator configured to receive the waste powder and melt the waste powder, and a container configured to collect the molten waste powder. A method may include generating a waste powder during 3-D printing of a printed part, collecting the waste powder in a passivator, heating the passivator to melt the waste powder, and collecting the molten waste powder. Aspects of this disclosure can include the passivator maintaining an inert environment.

### CROSS-REFERENCE TO RELATED APPLICATION

This application claims the benefit of U.S. Patent Application No. 63/601,992, entitled “WASTE METAL POWDER PASSIVATION” and filed on Nov. 22, 2023, which is expressly incorporated by reference herein in its entirety as if set forth herein.

### BACKGROUND

### Field

The present disclosure relates generally to additive manufacturing, and more particularly, to systems and methods of passivation of waste metal streams during additive manufacturing.

### Background

Powder-bed fusion (PBF) and directed energy deposition (DED) three-dimensional (3-D) printing systems operate by melting metal powder in an inert atmosphere, such as argon or nitrogen, to manufacture a solid 3-D printed structure. Metal powder, such as aluminum, is extremely reactive with oxygen and is a potential explosion hazard when exposed to environments having air or moisture. When particle size is sufficiently small, ratio of mass to surface area becomes minimal, leading to much of the aluminum mass being converted to oxide. This makes the small powders highly flammable which can ignite and burn in air. Pure aluminum can have combustion temperatures as low as 650 degrees Celsius. Rapid combustion can produce large amounts of gaseous material that could be explosive in a confined environment.

During the 3-D printing procedure, the potential for the metal powder to react with oxygen to cause a runaway oxidation or moisture reaction is eliminated by ensuring the process is carried out in an inert environment. Therefore, melting of the powder and subsequent solidification of the melted mass into a structure generates no potential catastrophic reactions. After completion of printing process and separation of printed structure from waste powder, the printed structure can be exposed to normal atmospheric conditions without the danger of a catastrophic reaction. However, unused waste powder remains and continues to be at risk of causing a dangerous oxidation reaction. Collecting waste powder in, for example, waste metal containers, still poses a reaction risk as the waste powder can still cause oxidation reactions during transfer from the 3-D printing system and processing of the waste metal containers as it is moved outside the inert environment.

Accordingly, there is a need for safe passivation of waste metal powder generated during 3-D printing processes to prevent dangerous oxidation reactions caused by waste powder.

### SUMMARY

Several aspects of a waste metal powder passivation apparatuses and methods are described more fully hereinafter.

In an aspect of the present disclosure, an apparatus for waste metal powder passivation is presented. The apparatus includes a three-dimensional (3-D) printer, in which the 3-D printer produces a waste powder during 3-D printing of a printed part. The apparatus also includes a passivator configured to receive the waste powder and melt the waste powder. The apparatus further includes a container configured to collect the molten waste powder.

In one or more embodiments, the apparatus further includes a pump configured to circulate an inert gas through the apparatus to create a gas flow with the waste powder. For example, the gas flow can be continuous. Further, the passivator of the apparatus can receive the gas flow with the waste powder.

In one or more embodiments, the apparatus further includes a filter. The filter can be heated. For example, the passivator can be induction heated. Further, the passivator of the apparatus can be configured to receive and melt the filter.

In one or more embodiments, the apparatus further includes a rotation mechanism for rotating the passivator. In one or more embodiments, the apparatus further includes a cyclone separator. In one or more embodiments, the apparatus further includes a moisture extraction dryer.

In one or more embodiments, the passivator of the apparatus further includes an electrostatically charged portion. In one or more embodiments, the passivator of the apparatus further includes an outlet.

In another aspect of the present disclosure, a method of waste powder passivation is presented. The method includes generating, by a three-dimensional (3-D) printer, a waste powder during 3-D printing of a printed part. The method further includes collecting the waste powder in a passivator. In one or more embodiments, the passivator includes a filter for collecting the waste powder. Moreover, the method includes heating the passivator to melt the waste powder. Additionally, the method includes collecting the molten waste powder. In one or more embodiments, the molten waste powder is collected through an outlet of the passivator. In one or more embodiments, the passivator maintains an inert environment. For example, the inert environment can be argon gas or nitrogen gas.

In one or more embodiments, the method includes circulating an inert gas to the 3-D printer to create a gas flow with the waste powder. Further, the method can include passing the gas flow with the waste powder to the passivator.

In one or more embodiments, the method includes applying an electrostatic charge to the gas flow to attract the waste powder to the passivator, in which the passivator includes an electrostatically charged portion. In one or more embodiments, the method includes centrifugally rotating the passivator to separate the waste powder from the gas flow. In one or more embodiments, the method includes passing the gas flow to a cyclone separator to remove coarse waste powder particles. In one or more embodiments, the method includes circulating the gas flow to a moisture extraction dryer. In one or more embodiments, the method includes re-circulating the gas flow to the 3-D printer.

In one or more embodiments, the method includes melting the filter with the collected waste powder. In one or more embodiments, the method includes melting the passivator.

In another aspect of the present disclosure, the method includes generating, by a three-dimensional (3-D) printer, a waste powder during 3-D printing of a printed part. The method further includes circulating an inert gas to the 3-D printer to create a gas flow with the waste powder. Moreover, the method includes passing the gas flow with the waste powder to the passivator. Further, the method includes agitating the gas flow with the waste powder to create a waste powder slurry. The method also includes collecting the waste powder slurry from an outlet of the passivator. In one or more embodiments, the passivator contains an aqueous solution.

In another aspect of the present disclosure, the method includes generating, by a three-dimensional (3-D) printer, a waste powder during 3-D printing of a printed part. The method further includes circulating an inert gas to the 3-D printer to create a gas flow with the waste powder. Moreover, the method includes passing the gas flow with the waste powder to the passivator. Further, the method includes mixing the waste powder with a reactant to solidify the waste powder. The method also includes collecting the inert gas from an outlet of the passivator.

Other aspects will become readily apparent to those skilled in the art from the following detailed description, wherein is shown and described only several example embodiments by way of illustration. As will be realized by those skilled in the art, concepts described herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of the concepts described herein will now be presented in the detailed description by way of example, and not by way of limitation, in the accompanying drawings, wherein:

FIG. 1 illustrates an apparatus for passivating waste powder according to one or more embodiments herein.

FIG. 2 illustrates an apparatus for passivating waste powder according to one or more embodiments herein.

FIG. 3 illustrates an apparatus for passivating waste powder according to one or more embodiments herein.

FIGS. 4A and 4B illustrate an apparatus for passivating waste powder according to one or more embodiments herein.

FIGS. 5A-5B are a flowchart that illustrates methods for waste powder passivation according to one or more embodiments herein.

FIG. 6 is a flowchart that illustrates methods for waste powder passivation according to one or more embodiments herein.

FIG. 7 is a flowchart that illustrates methods for waste powder passivation according to one or more embodiments herein.

### DETAILED DESCRIPTION

The detailed description set forth below in connection with the appended drawings is intended to provide a description of various example embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure. Dashed lines are used in the figures to indicate elements that may be optional.

While this disclosure is generally directed to laser-based PBF (L-PBF) or DED systems, it will be appreciated that such systems may encompass a wide variety of AM techniques. Thus, the additive manufacturing process may include, among others, the following printing techniques: Direct metal laser sintering (DMLS), Selective laser melting (SLM) and Selective laser sintering (SLS). Still other additive manufacturing processes which are capable of melting powder during the printing process to which the principles of this disclosure are pertinent include those that are currently contemplated or under commercial development. For example, powder can be heated by induction, heating coils, lasers, flame, and any other heating methods available to the arts. While the specific details of each such process are omitted to avoid unduly obscuring key concepts of the disclosure, it will be appreciated that the claims are intended to encompass such techniques and related structures.

During additive manufacturing of a structure, waste metal powder is generated during the laser beam induced fusion of a 3-D printer. Waste metal powder is generated in at least two ways during printing: (1) from unused powder in the 3-D printer's powder bed; and (2) powder collected by filters as condensate during printer operation.

Waste metal powder, including powder generated as waste from the 3-D printing process, is an extremely dangerous material that, if exposed to air and/or moisture, can initiate runaway oxidation reactions that generate heat and hydrogen. Further, as filters collect more waste powder, the risk of an oxidation reaction increases. In order to minimize the danger from oxidation reactions, the waste metal powder generated during the 3-D printing process must be removed from the area where the 3-D printed structure is being printed. Collection of waste powder in quantity for removal from the 3-D printing area poses a hazardous situation for personnel and facility that can lead potentially to risk of fire and catastrophic explosion.

Solutions for removing the waste metal powder may include batchwise removal of waste powder away from the source of generation. The batch process entails collection of powders in filters and dedicated containers, followed by transfer to remote storage and processing locations where the waste powder may be passivated, such as by receiving water in a controllable matter. However, these solutions still pose oxidation risks prior to their passivation even when transferred to the remote storage and processing locations. When waste powder is collected in large quantities prior to removing the waste from the 3-D printing area for transport, oxidation reactions can still occur and the risk can be higher since the waste powder has not been subject to passivation. Fine metal powder is a potential hazard, and the larger the stored quantity of waste metal powder and the finer the waste powder is when collected for downstream processing, the greater the level of potential damage, both in human and facility terms, which may occur during a runaway oxidation incident. Additionally, batchwise processing solutions may require transport of the waste powder to specific processing locations from the 3-D printing location. The longer that the waste powder remains outside of an inert, dry, gas environment, the greater the chances of an oxidation event. Thus, collected waste powder may require continuous monitoring to ensure that oxidation does not occur in sufficient quantities to cause a runaway reaction.

Accordingly, this disclosure may provide solutions to mitigate, in a safe and viable manner, hazards associated with handling of waste metal powder. In particular, this disclosure provides solutions to handling waste metal powder without needing to collect, handle, and dispose of waste metal powder in bulk. In one or more embodiments herein, the disclosed solution includes passivation of generated waste powder in a continuous manner at the site of the 3-D printing, which prevents accumulation of such waste metal powder. As disclosed herein, passivation means to process waste powder to reduce the potential for an oxidation reaction.

In an aspect, this disclosure provides apparatuses and methods for passivating waste powder by melting and subsequently solidifying waste powder in an inert gas environment during or after the printing process. The passivation is carried out in an inert environment at or near the 3-D printer, which passivates the waste powder as it is collected. Further, passivation of generated waste metal powder may be performed in small quantities, ideally continuously or nearly continuously during or after the 3-D printing process, such that at the time waste powder is generated the potential chance for damage caused by any catastrophic event is minimized. In one or more embodiments, the inert environment includes a gas stream that passes through the 3-D printer and/or collection filters to prevent oxidation reactions.

Metal powder passivation can occur at the location of the waste powder generation within each printing unit, or the waste metal powder can be transferred to a central processing location either batch wise or continuously. Continuous transfer can be carried out by use of an inert gas stream which carries the suspended metal powder. For example, the inert gas can be argon or nitrogen.

An advantage of waste metal passivation by melting and solidification is substantial cost savings over alternative batch wise transfer methods. Another advantage is that passivation of waste powder at the printing location permits the potential for recycling of waste powder. The solid metal bulk collected during passivation can be processed into ingots of standard dimensions much larger than the waste powder particle size. These ingots may be re-used as feed stock for future 3-D printing or utilized in other industries that use the metal ingots as feed stock.

In this disclosure, reference to waste powder or waste metal powder includes, but is not limited to, powders that are generated in the printing process that are termed “condensate.” For example, when a laser beam in an LPBF system heats metal powder, some of the metal can be vaporized and be carried away by the gas flow. This vaporized metal is also known as condensate. These condensates are expected to be the most reactive fraction of the waste powders and are potentially collected from cyclones and filters associated with the 3-D printing apparatuses. Alternatively or in addition, waste powder or waste metal powder may include powder that is left over, e.g., in the bed, after printing. This waste powder may have a larger particle size and lower reactivity than condensate. For example, the waste powder particles can range from 1 to 400 microns in size.

In one or more embodiments, the apparatuses and methods contemplated herein can include one or more 3-D printers, each 3-D printer generating separate waste metal powder that is collected in an inert gaseous environment and provided to a passivator. The waste metal powder is dried and kept non-reactive by the inert gas before it is collected and removed from the 3-D printing system or re-distributed to the 3-D printer for further printing.

The filtration and/or passivation apparatuses and methods disclosed herein are not intended to be restricted to the specific embodiments set forth herein. These apparatuses and methods can be implemented individually or in any combination with one another.

In an aspect of the disclosure, the passivation techniques herein are directed to collecting waste metal powder, such as condensate, captured in an inert gas stream and melting the waste metal powder by a passivator. A passivator as disclosed herein is a structure capable of receiving waste powder from 3-D printing processes and melting the waste powder for a container to receive the molten waste powder (e.g., melting and cooling of waste powder into a solid ingot). In one or more embodiments, the apparatuses herein are configured to receive an inert gas stream that passes through the 3-D printer, passivator, and container collecting the waste powder. In one or more embodiments, the apparatuses herein include a filter that separates the waste powder from the inert gas stream and collects it in a filter or container where is can be passivated by heating the powder until the powder particles coalesce into a size in which oxidation reactions are less likely. For example, the filter can be a cyclone separator or a filter mesh.

In one or more embodiments, the passivator and/or the collection containers can be the containers used for storage of printed generated waste powder, which are coupled to the 3-D printers and are kept under inert atmospheres such as argon or nitrogen. It is envisioned that the passivator can be fitted with special jackets or heating elements such that the temperature of passivator, or parts of the passivator, can be adjusted to cause melting of the waste powder collected in it. In one or more embodiments, the passivator may have heating and cooling capability in desired sections along its height that are configured to heat and cool desired sections.

Once the first portion of the waste powder is collected in the passivator, which can be disposable in nature, the heating process will be initiated to melt the waste powder. The heating process may be designed to be interactive and heat the passivator only in sections that have freshly deposited metal powder. This procedure will allow the melted waste powder to melt and coalesce into a pool or pools of molten metal, then cool to solidify, potentially by use of a cooling mechanism, to ambient temperature. The top layer of the cooled metal, together with freshly deposited powder, may then be heated to repeat the process.

In one or more embodiments, the passivator include heat insulative materials. Such heat insulative materials may assist in separating the heating and cooling zones in the passivator and/or the molten waste powder container. These materials may be based on powders such as sand, or fire-resistant chemicals. These materials can be added in portions to the waste metal powder to generate a layer of heat insulation for the waste powder. The goal of this addition is to insulate the already melted and cooled bulk waste metal from the waste powder layer that is to be melted.

In one or more embodiments, the collected waste powder is heated in small portions, thus alleviating the need for collection of larger volumes of bulk metal post melting and solidification. Smaller volumes can lead to easier automation for removal from the collection point in the 3-D printer and preclude a potential need for heating/cooling zones on the same collection container. Such a process could be carried out by collection of powder in a smaller pan, heating to melt, cooling to solidification, and an automated removal of the small pan to a central location which is under an inert environment. Finally, the solid collections can be removed from the inert containment. The solid metal pieces collected may be used as feedstock for preparation of new metal powder to be used in future 3-D printing processes. The molten metal can be collected on mass or used to fill molds with desired shapes. The molten metal can be analyzed and mixed with specific elements to enable use for high-end metal market such as powder metallurgy, or 3-D printing.

In one or more embodiments, the passivator and/or the collection containers have the capability to determine and notify the printer/operator of the powder/bulk metal fill level. In one or more embodiments, the passivator and/or the collection containers can determine whether the powder has solidified to a bulk form, e.g., via sound wave penetration.

In another aspect of the disclosure, the passivation process is performed continuously during the 3-D printing process. In a continuous passivation process, generated waste powder is passed directly to a passivator that is, or has, a crucible, furnace or other heat capable container such where the waste powder is melted and becomes molted metal. The passivator can heat the waste powder by various methods such as induction heating, though the heating method must be sufficient to ensure that the temperature of the waste powder reaches its melting point. For example, the passivator can be capable of heating the waste powder in excess of 660 degrees Celsius (the melting point of aluminum). Additionally, the heating process may occur in-line during gaseous transfer of the waste powders to the passivator, or in a container at the 3-D printer or as disclosed elsewhere herein. For example, the containers connected to the 3-D printer that are used for storage of printed generated waste powder can be kept under inert atmospheres and fitted with special jackets or heating elements such that the temperature of container, or parts of the container, can be adjusted to cause melting of the waste powder that is released into it. In one or more embodiments, the molten metal is not permitted to cool to solidification in the passivator, but instead flows out of the container for further processing.

The waste powder can be passed to the passivator directly or via an inert gas flow mixed with waste powder particles. In continuous passivation methods involving an inert gas flow, the process is in-line with the flow of waste powder to and from the 3-D printer. In one or more embodiments, the passivator can include a filter that collects waste powder passing through the crucible. For example, the filter can be a mesh. In one or more embodiments, the filter is a heated high temperature mesh capable of withstanding temperatures sufficient to melt the waste metal powder. For example, the filter can be an aluminum silicate filter. In one or more embodiments, the surfaces of the passivator are heated to perform additional waste powder melting. Furthermore, the filter is of sufficient size, thickness, and shape to ensure a complete conversion of the waste powder particles in the gas flow to a melted form. The pressure of the gas flow should be sufficient to blow the melted metal onto the surrounding hot walls of the passivator, which will direct the melt to a collection container. This process may be carried out in conjunction with other actions that increase the powder melt rate, increase the molten metal collection rate, or assist with inert gas flow, such as rapid vibration of the filter and passivator generally, or centrifugal rotation of the passivator. By passing through the passivator, the inert gas is scrubbed of the suspended waste metal particles and may then be directed back to the 3-D printer.

In one or more embodiments, the filter is made of a material having a melting point below the melting point of the passivator. For example, the filter can be composed of a material having a melting point at or near the melting point of the waste powder. For example, in printing systems that print with aluminum powder, the filter can be aluminum. In this way, the filter is meltable during heating operations of the passivator. In one or more embodiments, the filter is suspended above the crucible where it collects waste powder from the inert gas flow. In one or more embodiments, the filter can be pressure sensitive. For example, upon reaching a certain back pressure the filter would experience a rapid back flow of inert gas to dislodge trapped waste metal particles and cause them to fall into the crucible. Once the backflow procedure is completed the filter continues its standard operation. At certain intervals it may be advantageous to change the filter itself. The process can be initiated by dropping the filter into the crucible. Replacement filters can be arranged to automatically replace the dropped filter without the need for opening the housing and interrupting the printing procedure. The advantage of this arrangement is that an ordinary filter unit can be used without the requirement for high temperature materials. The filter material can also be chosen to impact on the total melted alloy composition, once the filter is melted into a melt pool.

In embodiments in which the filter component of the passivator is located in a heated container (e.g., oven, crucible, furnace), the seals which keep the inert gas environment maintained must function in the increased temperature. After cooling, the filter component may be opened or subjected to water (or aqueous NaOH solution) prior to opening.

In situations where the waste powder includes very small particles, after the inert gas flow condensate including the waste powder passes through a filter component to remove coarser particles, the gas flow can be directed to a scrubbing station. This station will flow the waste powder carrying inert gas flow through water, or an aqueous solution of NaOH, and then into a gas drying station (e.g., a moisture extraction dryer) to permit reuse of the inert gas. Care must be taken to ensure synthesized hydrogen gas is collected or ejected in a safe manner.

In one or more embodiments, the passivator can include an electrostatic element capable of creating an electromagnetic field arranged to attract waste metal powder particles from the inert gas flow. In this way, the waste powder can be filtered from the inert gas flow. For example, the electrostatic clement can be one or more charged metal plates, grids, rods, cups, or the like. In one or more embodiments, the electrostatic element can be heated to melt the collected waste powder.

In one or more embodiments, the passivator can include a centrifugal filter unit and a crucible. For example, the centrifugal filter unit of the passivator can be made of a high temperature filter material designed in the shape of cylinder. The filter material permits waste powder to be filtered out of the inert gas stream as the stream flows from outside of the filter to the interior of the centrifugal filter unit. In one or more embodiments, the inert gas stream containing the waste powder can flow through an entry port or inlet in the centrifugal filter unit. In one or more embodiments, the inert gas stream containing the waste powder can flow through the filter material that makes up an outer surface of the centrifugal filter unit (e.g., on catch walls). The centrifugal filter unit is configured to rotate around a longitudinal central axis during operation which further causes the waste powder (which is heavier than the inert gas) to be forced toward the filter material on the exterior of the unit. In one or more embodiments, the centrifugal filter unit includes an exit port or outlet for the filtered inert gas to be returned to printing machines or to be transferred for further processing. The exit port or outlet can be coupled to a tubular shaft that extends into the interior of the centrifugal filter unit. In one or more embodiments, the passivator includes a crucible surrounding the centrifugal unit capable of heating waste powder to its melting point. The crucible functions as a jacket that can be heated to melting temperature of the waste powder. In one or more embodiments, the melting point of the centrifugal filter unit is higher than the melting point of the waste powder. In one ore more embodiments, the melting point of the centrifugal filter unit is less than the temperature that the crucible can heat the centrifugal filter unit to. In this way, the centrifugal unit can be melted along with the waste powder. The crucible can also include an exit port or outlet for molten waste powder to flow out of the passivator. This outlet can be a tubular structure located at the bottom of the passivator where gravity can cause the molten waste powder to flow toward and through the outlet. In one or more embodiments, the outlet is coupled to or leads to a collection container for the molten waste powder.

The passivator can be composed of one or more of the elements disclosed herein. For example, the passivator can further include electrostatic elements as disclosed elsewhere herein in conjunction with the centrifugal filter unit and/or crucible. The speed of the centrifugal unit rotation, temperature, gas flow (which may be designed to allow intermittent reverse flow) may be used to optimize filter regeneration. The passivator may be used in a continuous manner by maintaining high temperature, or in a batch wise manner where the unit is placed offline for regeneration. In the event a filter element is placed offline, a replacement set up will automatically be connected to ensure process is continued with minimal interruption.

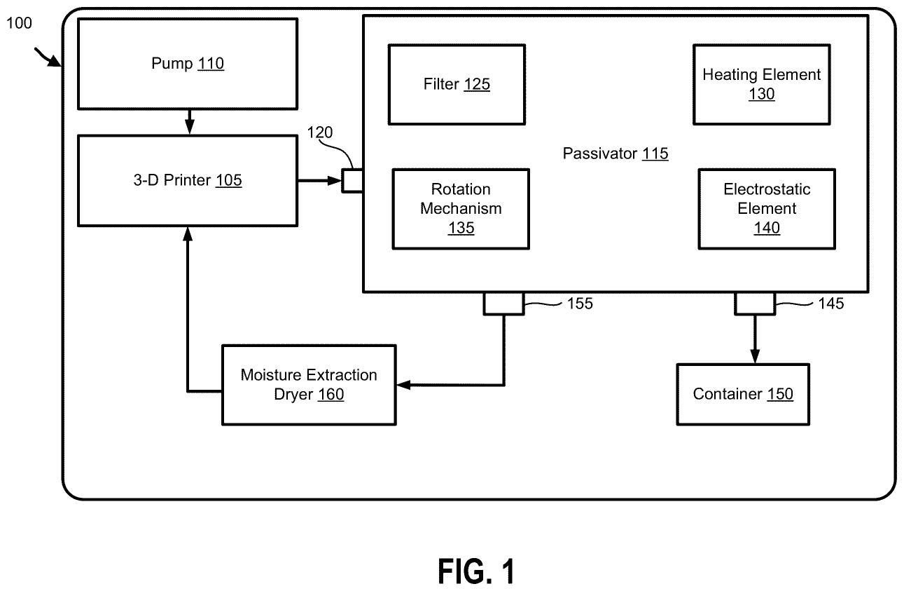

With reference to FIG. 1, an apparatus 100 for passivating waste powder is provided. The apparatus includes one or more 3-D printers 105 capable of additively manufacturing structures using metal powder based laser-based techniques. During or after 3-D printing, a pump 110 provides an inert gas flow into the printing area to capture waste powder and form a “dirty gas” of the inert gas and waste powder (e.g., condensate). For example, the inert gas can be argon or nitrogen. The gas flow is directed to a passivator 115 through an inlet 120. The inlet 120 can be, for example, a tube coupled to, or in air flow connection with, the inert gas flow pumped to the 3-D printer 105. The passivator 115 is configured to receive the gas flow and separate the waste powder from the gas flow and passivate it to limit or minimize the chances that a large oxidation reaction will occur if the waste powder is exposed to air or moisture.

The passivator 115 can include one or more components to perform passivation including a filter 125, a heating element 130, a rotation mechanism 135, and/or an electrostatic element 140.

The filter 125 receives the gas flow and filters the waste powder from the gas flow. In one or more embodiments, the filter 125 forms part of the surface of the passivator. In one or more embodiments, the filter 125 is a cyclone filter, a filter mesh, a thermally conductive woven metal mesh, or a centrifugal filter unit. In one or more embodiments, the filter 125 is contained within the passivator 115 or contained within other elements of the passivator such as heating element 130. The heating element 130 can be any element capable of heating the passivator to raise the temperature in the passivator sufficiently to melt waste powder contained within the filter. For example, the heating element 130 can be an induction heater, a crucible, a furnace, a heated jacket, coils contained within or adjacent to the containing surfaces of the filter 125, as described elsewhere herein. As the waste powder melts, it coalesces and flow in to catch basins that will direct the metal to the catch containers (e.g., container 150). This process may be carried out in conjunction with rapid vibration of the filter 125 to enhance separation of the liquified metal. It is understood that this process is carried out in an inert atmosphere where gases such as argon or nitrogen are maintained.

The rotation mechanism 135 can be coupled to or form part of the filter 125 in various embodiments. In this way, the rotation mechanism 135 can provide rotational motion to the filter and the resulting centrifugal force can be used to separate the waste powder from the inert gas flow.

The electrostatic element 140 can include one or more electrically charged plates, grids, rods, cups, or the like that are used to create electromagnetic fields in the passivator 115. As waste powder like aluminum is often able to be attracted by electric charge, these electromagnetic fields can be configured to attract waste powder particles from the gas flow and draw them to the filter 125 or other suitable location.

As the waste powder is collected in passivator 115, the heating element 130 increases the temperature of the waste powder to its melting point. For example, the melting point of aluminum is approximately 660 degrees Celsius. As the waste powder melts, it forms molten waste powder. This molten waste powder is guided to an outlet 145, which may be a tube, conical section, or other outlet as is known in the art, where it exits the passivator to a container 150. The container 150 is a collection container designed to safely collect the molten waste powder where it can coalesce and cool with less or no risk of an oxidation reaction. Thereafter, the collected waste powder can be processed continuously or batch wise to remove the waste powder from the 3-D printing environment or to recycle it for future printing use.

In one or more embodiments, the passivator 115 further includes a gas outlet 155. The gas outlet 155 can be a tube, conical section, or other similar structure that permits the inert gas to leave the passivator 115 once the waste powder has been filtered from the gas flow. In this way the gas flow can be “cleaned.” Thereafter, the gas flow may pass to a moisture extraction dryer 160, which can dry the gas flow and remove any moisture that it had picked up. Once the gas flow is dry, the gas flow can be pumped back to the 3-D printer 105 to be used to pick up additional waste powder created at the 3-D printing powder bed.

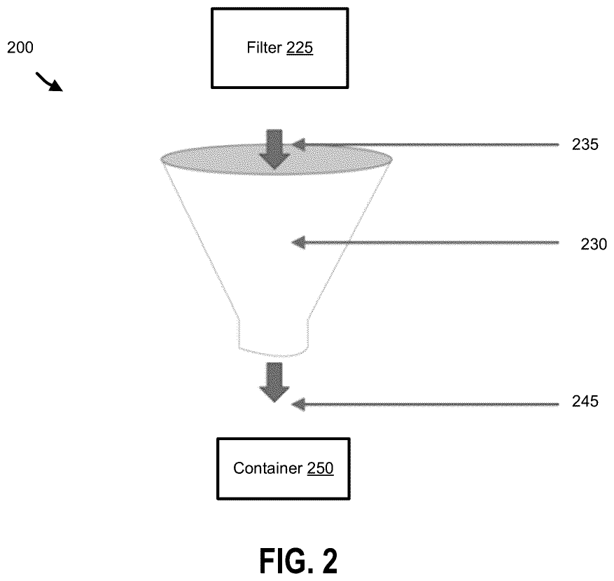

With reference to FIG. 2, a passivator 200 is provided. As disclosed herein, the passivator 200 can receive inert gas including waste powder particles (such as condensate) that are heated to melt the particle for collection and removal from the 3-D printing environment. In one or more embodiments, the waste powder is provided directly to a heating element 230, such as a crucible. The heating element 230 can be heated by induction, heating coils, laser, flame, or other heating solutions known to those in the art. In an embodiment, the heating clement 230 includes a conical design in which the waste powder is provided to the heating clement by a wide open mouth 235, heated in the body of the heating element, and passed as molten waste powder to a narrower outlet 245, which may be a tube, conical section, or other outlet as is known in the art. After the molten waste powder flows out of the outlet 245, it can be collected in a container 250 for processing.

The passivator 200 can optionally include a filter 225 as disclosed elsewhere herein that can receive inert gas including waste powder particles. In one or more embodiments, the filter 225 is made of the same material as the waste powder, or a material having a melting point at or near the melting point of the waste powder. For example, in printing systems printing with aluminum powder, the filter 225 can be aluminum. Thus, once the filter 225 receives the waste powder, it can be dropped into the heating element 230 and the filter and waste powder combination can be melted into molten waste and passed to the container 250 through the outlet 245.

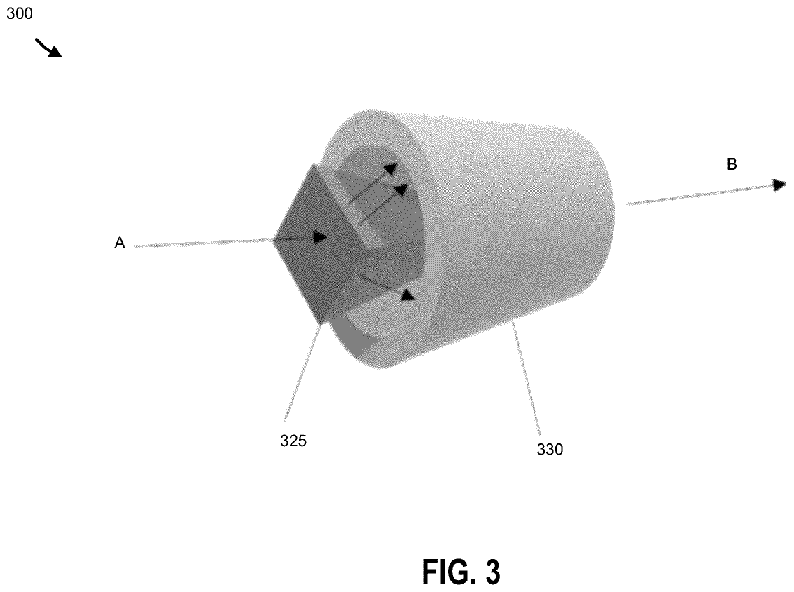

With reference to FIG. 3, a passivator 300 is provided. As disclosed herein, the passivator 300 can receive inert gas including waste powder particles, such as condensate, that are heated to melt the particle for collection and removal from the 3-D printing environment in a continuous manner. The passivator 300 includes a filter 325 and a heating element 330. The filter 325 may be, for example, a filter mesh. In one or more embodiments, the filter 325 is made of material having a melting point above that of the waste powder to ensure that it remains solid during melting of the waste powder. The heating element 330 can be crucible, furnace, or other heat capable container that is gaseous impermeable. As the filter 325 collects the waste powder from the inert gas, the heating element 330 raises the temperature to melt the waste powder. The molten waste powder exits the heating element 330 by way of an outlet and is collected in a container, as disclosed elsewhere herein. The inert gas flow is provided to the passivator 300 as shown in FIG. 3 by the flow shown by reference letter A (indicating the “dirty” gas flow's entry into the filter 325) and reference letter B (indicating the “clean” gas flow's (without waste powder) exit from the heating element 330).

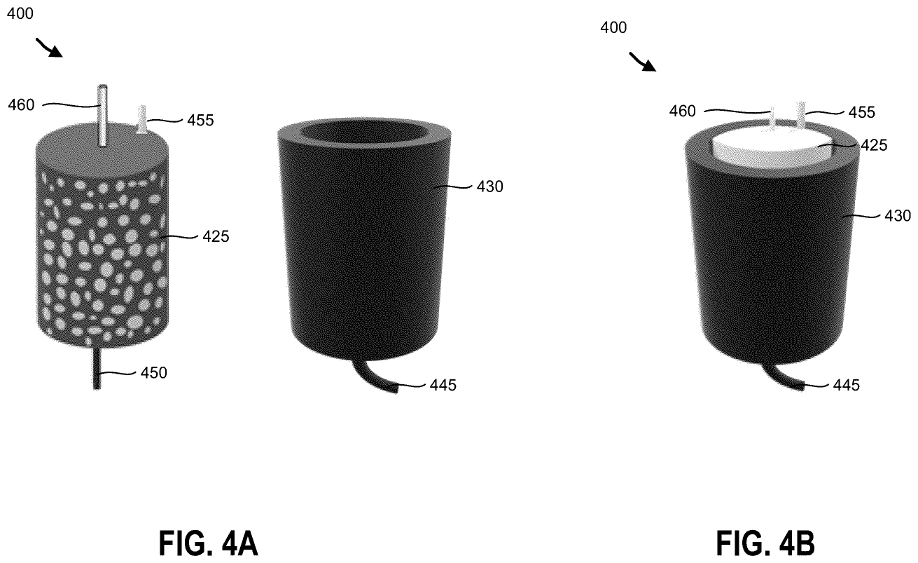

With reference to FIGS. 4A and 4B, a passivator 400 is provided. As disclosed herein, the passivator 400 can receive inert gas including waste powder particles, such as condensate, that are heated to melt the particle for collection and removal from the 3-D printing environment and can also provide rotational movement to create a centrifugal force to further separate the inert gas from the waste powder. The passivator 400 includes a cylindrical filter unit 425 that is highly resistant to temperature. The filter 425 includes a central, longitudinal shaft 450 that is configured to provide rotational motion to the filter. The shaft 450 can be powered by a motor or other conventional means. The inert gas with waste powder enters the filter 425 through an inlet 455, which may be a tube, conical section, or other opening.

Surrounding the filter 425 is a heating element 430. The heating element 430 can be a crucible, furnace, heating jacket, or other mechanism for providing high temperature to the area surrounding the exterior surfaces of the filter 425. In one or more embodiments, the filter 425 is composed of material having a melting point in excess of the melting point of the waste powder.

Once the inert gas with waste powder enters the filter 425, the rotational motion provided by the shaft 450 serves to push the more massive waste powder particles toward the sides of the filter, near to the heating element 430. The high temperature provided by the heating element 430 serves to melt the waste powder to a molten waste powder. This molten waste powder collects near the bottom of the heating element 430 at or near an outlet 445. The outlet 445 may be coupled to the filter 425. As the molten waste powder collects, it exists the passivator 400 through the outlet 445 where it can be collected in a container or other receptacle as disclosed elsewhere herein. Additionally, the rotational motion and removal of the waste powder mass from the inert gas lightens the inert gas such that it rises and exits the filter through a filtered gas outlet 460. This gas outlet 460 can be placed in-line with other elements such as a moisture extraction dryer and/or 3-D printer to recycle the inert gas.

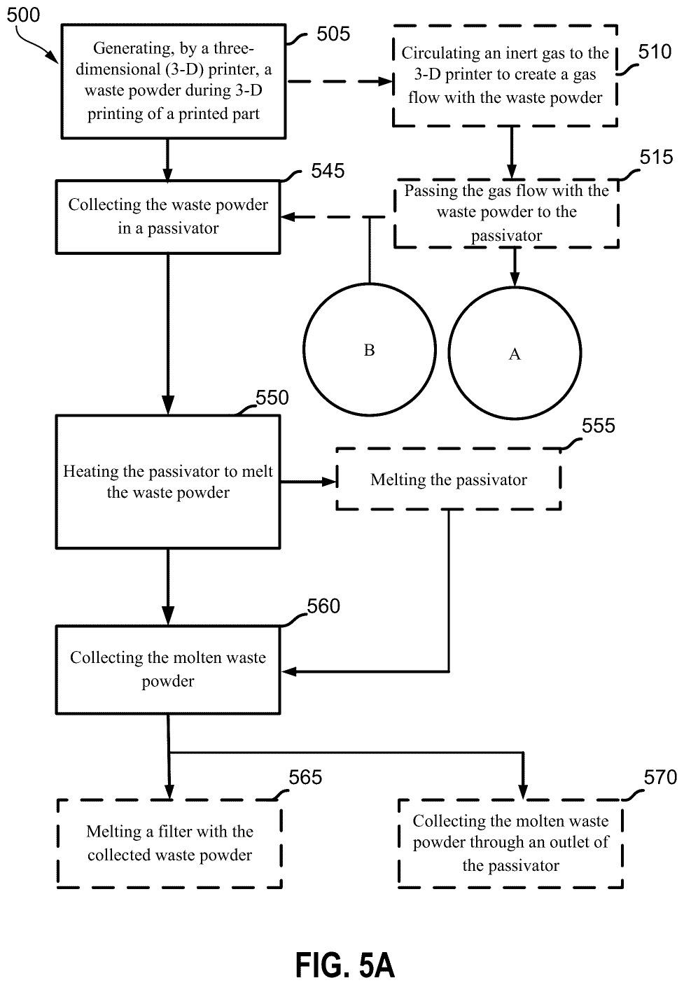

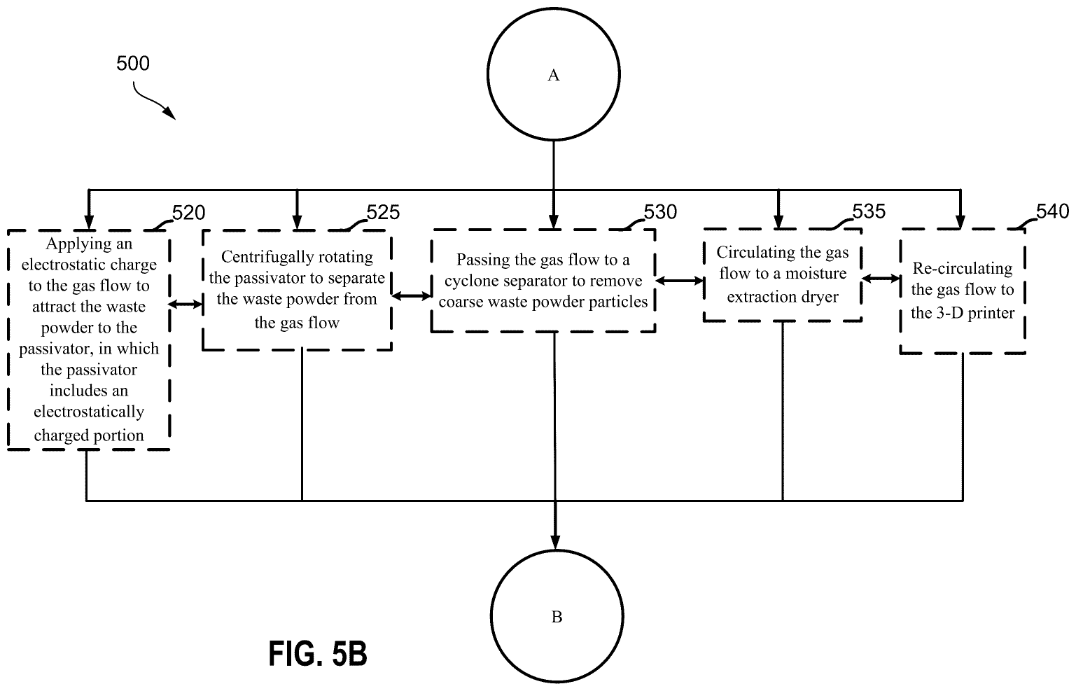

FIGS. 5A and 5B are flowcharts of an example method 500 of waste powder passivation according to the disclosure herein. The method 500 begins by generating, by a three-dimensional (3-D) printer, a waste powder during 3-D printing of a printed part, 505. The waste powder can be a metal, such as aluminum. The waste powder can be collected in a powder bed or in a container at the 3-D printer. The waste powder can be suspended in a gas flow, such as condensate carried away from the powder bed by a gas flow of inert gas.

In one or more embodiments, the method 500 may optionally continue by circulating an inert gas to the 3-D printer to create a gas flow with the waste powder, 510. For example, the inert gas can be argon or nitrogen. Thereafter, the gas flow is passed with the waste powder to a passivator, 515. The passivator may be any passivator as disclosed herein (e.g., passivator 115, 200, 300, 400) or any combination of elements of these passivator embodiments.

When the gas flow with the waste powder is passed to the passivator, the method 500 can manipulate the gas flow to separate the waste powder from the gas. This can be done in a number of ways, either separately or in combination with one or more options. In one or more embodiments, the method 500 applies an electrostatic charge to the gas flow to attract the waste powder to the passivator, in which the passivator includes an electrostatically charged portion, 520. In one or more embodiments, the method 500 centrifugally rotates the passivator to separate the waste powder from the gas flow, 525. In one or more embodiments, the method 500 passes the gas flow to a cyclone separator and/or filter to remove coarse waste powder particles and/or filter out waste powder particles, 530. In one or more embodiments, the method 500 circulates the gas flow to a moisture extraction dryer, 535, In one or more embodiments, the method 500 re-circulates the gas flow to the 3-D printer, 540. Thereafter, once the waste powder has been separated from the gas flow the waste powder is collected in the passivator, 545.

The method 500 continues by heating the passivator to melt the waste powder, 550. This creates a molten waste powder. In one or more embodiments, the passivator is heated to the melting point of the waste powder, but not to the melting point of the passivator or any of its components. In one or more embodiments, the passivator is melted, 555. The method 500 thereafter collects the molten waste powder, 560. The molten waste powder can be collected in various components, including filters, crucibles, containers, or other receptacles as disclosed elsewhere herein.

In other embodiments, only a portion of the passivator is melted. Thus, the method can also optionally or in addition continue by melting a filter with the collected waste powder, 565. For example, the filter in the passivator may be made of materials having a melting point that will cause it to be melted along with the waste powder when forming the molten waste powder.

The method can also optionally or in addition, collect the molten waste powder through an outlet of the passivator, 570. This outlet can be located at the bottom of the passivator, and gravity can pull the molten waste powder through the outlet to a collecting container, as disclosed herein.

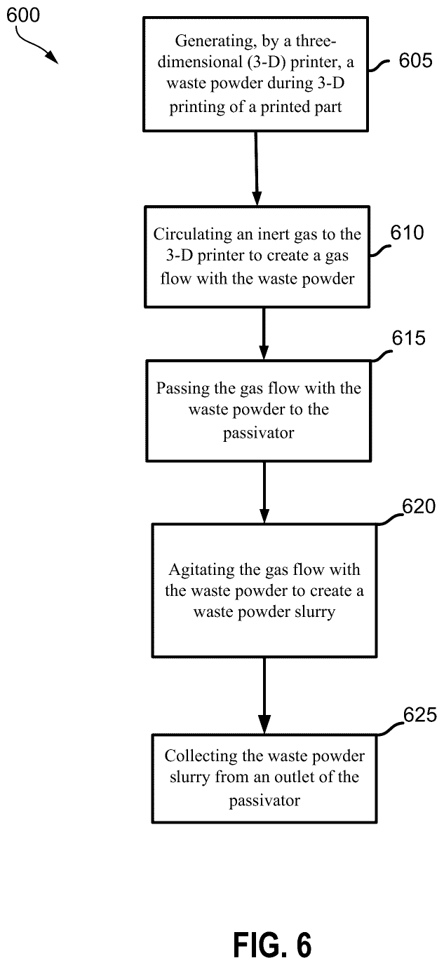

With reference to FIG. 6, a method of waste powder passivation 600 according to the disclosure herein is provided. The method 600 begins by generating, by a three-dimensional (3-D) printer, a waste powder during 3-D printing of a printed part, 605. The waste powder can be a metal, such as aluminum. The waste powder can be collected in a powder bed or in a container at the 3-D printer.

In one or more embodiments, the method 600 may optionally continue by circulating an inert gas to the 3-D printer to create a gas flow with the waste powder, such as condensate, 610. For example, the inert gas can be argon or nitrogen. Thereafter, the gas flow is passed with the waste powder to a passivator, 615. The passivator may be any passivator as disclosed herein (e.g., passivator 115, 200, 300, 400) or any combination of elements of these passivator embodiments. In one or more embodiments, the method 600 provides the waste powder to the passivator by physical conveyor or in combination with the gas flow. In one or more embodiments, the passivator contains an aqueous solution.

Once the waste powder is provided to the passivator, the passivator endeavors to scrub the waste powder, both in any containers, filters, separators, or other components with the aqueous solution. For example, the aqueous solution can be water alone, or a water solution containing bases or salts. Advantageously, the method 600 ensures that the waste powder is processed as it is generated by the 3-D printer (or in-line with the 3-D printer), and not collected in bulk prior to being transferred to storage and processing areas.

The method 600 continues by agitating the gas flow with the waste powder to create a waste powder slurry, 620. Agitation of the gas flow with the waste powder can be achieved in a number of different ways. For example, the passivator may subject the waste powder through a fine mist of the aqueous solutions, or alternatively pass through a curtain of the aqueous solutions, or alternatively be bubbled through the aqueous solution, or alternatively the waste powder is mixed with the aqueous solution by mixing mechanisms such as fans, blenders, mixers, or propellers. In one or more embodiments in which a mixing mechanism is implemented, the agitation provided by the mixing mechanism can generate heat, which is used to dissipate evolved gases. The temperature of the aqueous solution, as well as the concentration of bases or salts, if used, is adjusted for optimal treatment and processing of the waste powder. To the extent that treatment of the waste powder with the aqueous solution generates hydrogen gas, the hydrogen gas is collected or discharged according to methods already known and described in the literature.

The method 600 also collects the waste powder slurry through an outlet of the passivator, 625. This outlet can be located at the bottom of the passivator, and gravity can pull the waste powder slurry through the outlet to a collecting container, as disclosed herein.

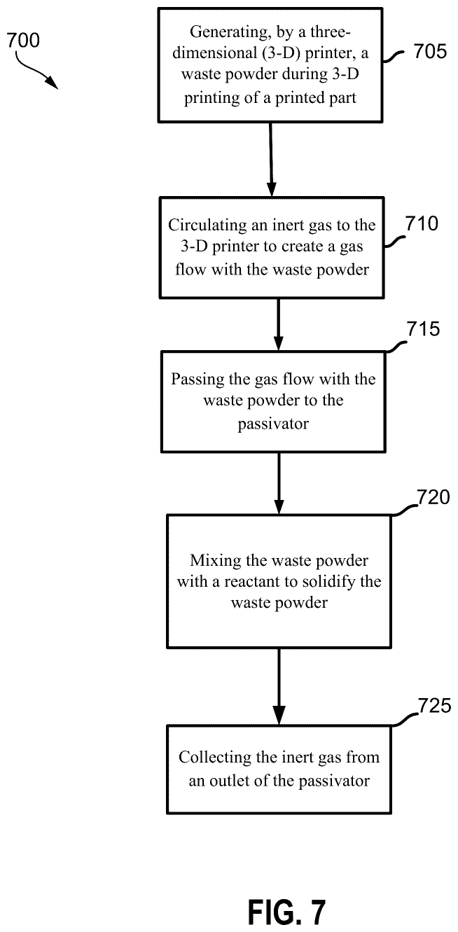

With reference to FIG. 7, a method of waste powder passivation 700 according to the disclosure herein is provided. The method 700 begins by generating, by a three-dimensional (3-D) printer, a waste powder during 3-D printing of a printed part, 705. The waste powder can be a metal, such as aluminum. The waste powder can be collected in a powder bed or in a container at the 3-D printer. When collecting waste metal powder, there is a potential hazardous situation when the waste powder is collected in bulk form. Thus, it is advantageous to separate the powder to permit more controlled oxidation and less chances of a runaway reaction.

In one or more embodiments, the method 700 may optionally continue by circulating an inert gas to the 3-D printer to create a gas flow with the waste powder, 710. For example, the inert gas can be argon or nitrogen. Thereafter, the gas flow is passed with the waste powder to a passivator, 715. The passivator may be any passivator as disclosed herein (e.g., passivator 115, 200, 300, 400) or any combination of elements of these passivator embodiments. In one or more embodiments, the method 700 provides the waste powder to the passivator by physical conveyor or in combination with the gas flow.

The method 700 continues by mixing the waste powder with an encapsulant or a reactant to solidify the waste powder, 720. The encapsulant or reactant may be a reactive material that solidifies via reaction, or a hot melt that solidifies on cooling, or a combination thereof. In one or more embodiments, the waste powder is mixed with the encapsulant or a reactant by mixing mechanisms such as fans, blenders, mixers, or propellers. The powder and encapsulant or reactant are fed into the mixing mechanism, thus mixing in a continuous manner, and are extruded continuously in a shape and size that is determined to be most optimal for safety and storage of the encapsulated powder. In one or more embodiments in which a mixing mechanism is implemented, the agitation provided by the mixing mechanism can generate heat, which is used to dissipate evolved gases. The encapsulant or reactant can be formulated to have desired moisture or oxygen permeation properties or be composed of fire resistant or extinguishing materials. Alternatively, the mixing mechanism can include (1) additives such as Butvar B-90 and (2) solvent (e.g., isopropyl, acetone) to passivate and consolidate the pure waste metal particles.

The method 700 also collects the waste powder slurry through an outlet of the passivator, 725. This outlet can be located at the bottom of the passivator, and gravity can pull the waste powder slurry through the outlet to a collecting container, as disclosed herein.

As used herein, the terms “waste metal powder,” “waste powder,” “metal powder” and similar include all waste metal that is generated during the 3-D printing process, including waste condensate, unless otherwise specified. However, this disclosure is not limited to waste metal powder generated in the additive manufacturing industry alone and includes all industries that have potential for generation of metal dust and particulates.

The previous description is provided to enable any person skilled in the art to practice the various aspects described herein. Various modifications to these example embodiments presented throughout this disclosure will be readily apparent to those skilled in the art, and the concepts disclosed herein may be applied to other support structures and systems and methods for removal of support structures. Thus, the claims are not intended to be limited to the example embodiments presented throughout the disclosure, but are to be accorded the full scope consistent with the language claims. All structural and functional equivalents to the elements of the example embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus comprising:
a three-dimensional (3-D) printer, wherein the 3-D printer produces a waste powder during 3-D printing of a printed part;
a passivator configured to receive the waste powder and melt the waste powder; and
a container configured to collect the molten waste powder.

2. The apparatus of claim 1, further comprising a pump configured to circulate an inert gas through the apparatus to create a gas flow with the waste powder.

3. The apparatus of claim 2, wherein the gas flow is continuous.

4. The apparatus of claim 2, wherein the passivator receives the gas flow with the waste powder.

5. The apparatus of claim 1, further comprising a filter.

6. The apparatus of claim 5, wherein the filter is heated.

7. The apparatus of claim 5, wherein the passivator is configured to receive and melt the filter.

8. The apparatus of claim 1, further comprising a rotation mechanism for rotating the passivator.

9. The apparatus of claim 1, wherein the passivator is induction heated.

10. The apparatus of claim 1, wherein the passivator includes an electrostatically charged portion.

11. The apparatus of claim 1, wherein the passivator includes an outlet.

12. The apparatus of claim 1, further comprising a cyclone separator.

13. The apparatus of claim 1, further comprising a moisture extraction dryer.

14. A method of waste powder passivation comprising:
generating, by a three-dimensional (3-D) printer, a waste powder during 3-D printing of a printed part;
collecting the waste powder in a passivator;
heating the passivator to melt the waste powder; and
collecting the molten waste powder,
wherein the passivator maintains an inert environment.

15. The method of claim 14, further comprising circulating an inert gas to the 3-D printer to create a gas flow with the waste powder; and
passing the gas flow with the waste powder to the passivator.

16. The method of claim 15, further comprising applying an electrostatic charge to the gas flow to attract the waste powder to the passivator, wherein the passivator includes an electrostatically charged portion.

17. The method of claim 15, further comprising centrifugally rotating the passivator to separate the waste powder from the gas flow.

18. The method of claim 15, further comprising passing the gas flow to a cyclone separator to remove coarse waste powder particles.

19. The method of claim 15, further comprising circulating the gas flow to a moisture extraction dryer.

20. The method of claim 15, further comprising re-circulating the gas flow to the 3-D printer.

21. The method of claim 14, wherein the passivator includes a filter for collecting the waste powder.

22. The method of claim 21, further comprising melting the filter with the collected waste powder.

23. The method of claim 14, further comprising melting the passivator.

24. The method of claim 14, wherein the molten waste powder is collected through an outlet of the passivator.

25. The method of claim 14, wherein the inert environment is argon gas or nitrogen gas.

26. A method of waste powder passivation comprising:
generating, by a three-dimensional (3-D) printer, a waste powder during 3-D printing of a printed part;
circulating an inert gas to the 3-D printer to create a gas flow with the waste powder;
passing the gas flow with the waste powder to the passivator;
agitating the gas flow with the waste powder to create a waste powder slurry; and
collecting the waste powder slurry from an outlet of the passivator,
wherein the passivator contains an aqueous solution.

27. A method of waste powder passivation comprising:
generating, by a three-dimensional (3-D) printer, a waste powder during 3-D printing of a printed part;
circulating an inert gas to the 3-D printer to create a gas flow with the waste powder;
passing the gas flow with the waste powder to the passivator;
mixing the waste powder with a reactant to solidify the waste powder; and
collecting the inert gas from an outlet of the passivator.
